(19) United States
(12) Patent Application Publication
(10) Pub. No.: US 2025/0324938 A1
(43) Pub. Date: Oct. 23, 2025

(54) STRUCTURE OF PET CAGE

(71) Applicant: Foshan BeeKoo Intelligent Technology Co.,Ltd, Foshan (CN)

(72) Inventor: Huasheng CHEN, Foshan (CN)

(21) Appl. No.: 18/749,815

(22) Filed: Jun. 21, 2024

(30) Foreign Application Priority Data
Apr. 22, 2024 (CN) 202420842528.2

(51) Int. Cl. A01K 1/02

(52) U.S. Cl. CPC A01K 1/02

(57) ABSTRACT

The present utility model discloses An improved structure of pet cage, including a frame body on which a long support rod is provided, wherein the long support rod includes two first connecting pipes, and one end of the two first connecting pipes is respectively provided with a first hinge joint and a second hinge joint that are hinged, and the other end of the two first connecting pipes is movably connected to the frame body, and one of the first connecting pipes is also provided with a sleeve that is sleeved around the hinge joint of the first hinge joint and the second hinge joint; this pet cage has an improved structure, during use, and allows for the relatively unfolding or folding of the two first connecting pipes simply through the movement of the sleeve, making the operation simple and convenient.

### CROSS-REFERENCE TO RELATED APPLICATIONS

This application claims the benefit and priority of Chinese patent application No. 202420842528.2, filed on Apr. 22, 2024, disclosure of which is hereby incorporated by reference in its entirety.

### TECHNICAL FIELD

The present utility model relates to the technical field of pet products, in particular to an improved structure of pet cage.

### BACKGROUND

Existing pet cages, when not in use, usually allow for easy collection based on a foldable structure. For example, Chinese utility model patent number: 2006200532998, name: a pet cage, date of Authorized Announcement: Feb. 28, 2007, the pet cage includes a bottom frame, U-shaped structured side brackets that are symmetrically disposed at both ends of the bottom frame, and symmetrical hinge supports are also provided at both ends of the bottom frame; the two ends of the U-shaped structured side brackets are inversely hinged on the supports; two hinge supports are provided on both sides of the crossbar of an inverted side bracket, and an upper support rod is hinged on the hinge support, and a sliding sleeve is sleeved on the upper support rod; hinge supports are symmetrically disposed on the crossbar of another inverted side bracket, and an upper support rod is also hinged on each hinge support; the ends of the two opposite upper support rods are inserted together to form a long support rod, and the sleeve is sleeved at the insertion point, and the bottom frame forms a square shaped cage structure together with side bracket and upper support rod. A square pet cage can be formed simply by inserting the two opposite support rods together, and then sliding the slidable sleeve onto the insertion point of upper support rod. When disassembly is needed, the slidable sleeve can be moved away from the insertion point, and each component can rotate around the hinge joint to fold together.

However, the improved structure of the pet cage mentioned above still has the following shortcomings: (1) The two opposite upper support rods are connected together through insertion, that is, the opposite end of the two upper support rods is provided with a plug and a slot, and the two upper support rods have different specific structures, and during installation, it is necessary to distinguish the two upper support rods of the pet case, otherwise it may cause installation errors and inconvenient installation; moreover, if one of the upper support rods is damaged, it is inconvenient to find a same one for replacement.

### SUMMARY

The purpose of the present utility model is to solve the shortcomings of prior art mentioned above, and to provide an improved structure of pet cage that have two first connecting pipes of the same structure and can be simply and conveniently installed without specific distinction.

The present utility model realizes the purposes as follows:

An improved structure of pet cage, including a frame body on which a long support rod is provided, wherein the long support rod includes two first connecting pipes, and one end of the two first connecting pipes is respectively provided with a first hinge joint and a second hinge joint that are hinged, and the other end of the two first connecting pipes is movably connected to the frame body, and one of the first connecting pipes is also provided with a sleeve that is sleeved around the hinge joint of the first hinge joint and the second hinge joint; this pet cage has an improved structure, during use, and allows for the relatively unfolding or folding of the two first connecting pipes simply through the movement of the sleeve, making the operation simple and convenient, and the two first connecting pipes have the same structure, so the installation becomes simple and easy without distinction, and the first connecting pipes, when damaged, can be easily replaced.

The purpose of the present utility model can also be solved by the following technical measures:

In further, one first connecting pipe is provided with an elastic limit buckle and the first hinge joint, and the elastic limit buckle is located on one side of the sleeve, while the other first connecting pipe is provided with a limit member and the second hinge joint, and the limit member is located on the other side of the sleeve; the fit between the elastic limit buckle and the limit member effectively limits the position of sleeve, so that the sleeve can be installed well at the hinge joint of the first hinge joint and the second hinge joint.

In further, the elastic limit buckle includes a V-shaped shrapnel and a limit buckle fixed at one end of the V-shaped shrapnel, the position of corresponding limit buckle on a first connecting tube is provided with a first through-hole, and the position of corresponding first through-hole on a first hinge joint is provided with a second through-hole, the V-shaped shrapnel is disposed inside the first connecting tube, and one end of the limit buckle extends outward outside the first through-hole and the second through-hole; when it is necessary to move the sleeve, simply press the limit buckle to move and contract along with the V-shaped shrapnel towards the inner side of first connecting pipe, so that the limit buckle will not affect the movement of the sleeve.

In further, the limit member is a annular limit ring, and the annular limit ring is connected to one side of the second hinge joint; the annular limit ring with simple structure can also play a good limiting effect.

In further, both first connecting pipes are provided with connecting through-holes, the first hinge joint is provided with a first connecting hole at the position corresponding to the connecting through-hole, the second hinge joint is provided with a second connecting hole at the position corresponding to the connecting through-hole, the first connecting hole is connected with a connector, and one end of the connector is connected to the connecting through-hole, the second connecting hole is connected with a connector, and one end of the connector is connected to the connecting through-hole, so that the first hinge joint and the second hinge joint can be stably connected to the corresponding first connecting pipe, and the connectors can be a connecting screw or rivet, which is easily available and has good fixing effect.

In further, The improved structure of pet cage includes a hinge piece, and the hinge piece is located between the first hinge joint and the second hinge joint, and the two ends of the hinge piece are respectively hinged with the first hinge joint and the second hinge joint; the hinge piece can provide a carrier for the hinge movement of the first and second hinge joints, and also facilitate the relative folding of the first and second hinge joints without interference.

In further, the frame body includes a bottom frame, four side support rods, and a top frame, the top frame includes four tee joints, two short support rods, and two long support rods, one end of the short support rod and one end of the long support rod in a similar position are movably connected to the two ends of the tee joint, so that the top frame forms a square frame body, the four tee joints on the top frame are respectively connected to the upper ends of the four side support rods, and the lower ends of the four side support rods are fixedly connected to the surrounding areas of the bottom frame; the side support rod realizes the connection between the bottom frame and the top frame, and both the short and long support rods can move along the tee joint, so that the folded product have a smaller overall volume and can be conveniently retracted.

In further, the short support rod includes two second connecting pipes, and one end of the two second connecting pipes is respectively provided with a third hinge joint and a fourth hinge joint that are mutually hinged, one of the second connecting pipes is further provided with a slidable sleeve, the slidable sleeve is sleeved around the hinge joint of the third hinge joint and the fourth hinge joint, and the other end of the two second connecting pipes is movably connected with the corresponding tee joint, respectively, allowing for the simple and convenient unfolding or folding of the two first connecting pipes, and the two first connecting pipes have the same structure, so the installation becomes simple and easy without distinction, and the second connecting pipes, when damaged, can be easily replaced.

In further, the third hinge joint has the same shape and size as the first hinge joint, the fourth hinge joint has the same shape and size as the second hinge joint, the bottom frame and top frame have the same shape and size, and the bottom frame and top frame are symmetrically disposed at the upper and lower ends of the side support rod, so that the pet cage involves fewer types of components, relatively simple overall structure and assembly and disassembly operation, thus facilitating the promotion and application of the product.

The beneficial effects of the present utility model are as follows:
(1) The improved structure of pet cage, during use, allows for the relatively unfolding or folding of the two first connecting pipes simply through the movement of the sleeve, making the operation simple and convenient, and the two first connecting pipes have the same structure, so the installation becomes simple and easy without distinction, and the first connecting pipes, when damaged, can be easily replaced.
(2) The fit between the elastic limit buckle and the limit member effectively limits the position of sleeve, so that the sleeve can be installed well at the hinge joint of the first hinge joint and the second hinge joint.
(3) This pet cage involves fewer types of components, relatively simple overall structure and assembly and disassembly operation, thus facilitating the promotion and application of the product.

### BRIEF DESCRIPTION OF DRAWINGS

FIG. 1 is a schematic diagram of the improved structure of pet cage in the present utility model.

FIG. 2 is an enlarged view of position A in FIG. 1.

FIG. 3 is a schematic diagram of the pet cage in FIG. 1 with sleeve removed.

FIG. 4 is an enlarged view of position B in FIG. 3.

FIG. 5 is a disassembly diagram of the improved structure of pet cage in the present utility model.

FIG. 6 is an enlarged view of position C in FIG. 5.

FIG. 7 is a schematic diagram of pet cage in folded state in the present utility model.

### DESCRIPTION OF EMBODIMENTS

The present utility model is further described in conjunction with the accompanying drawings and embodiments:

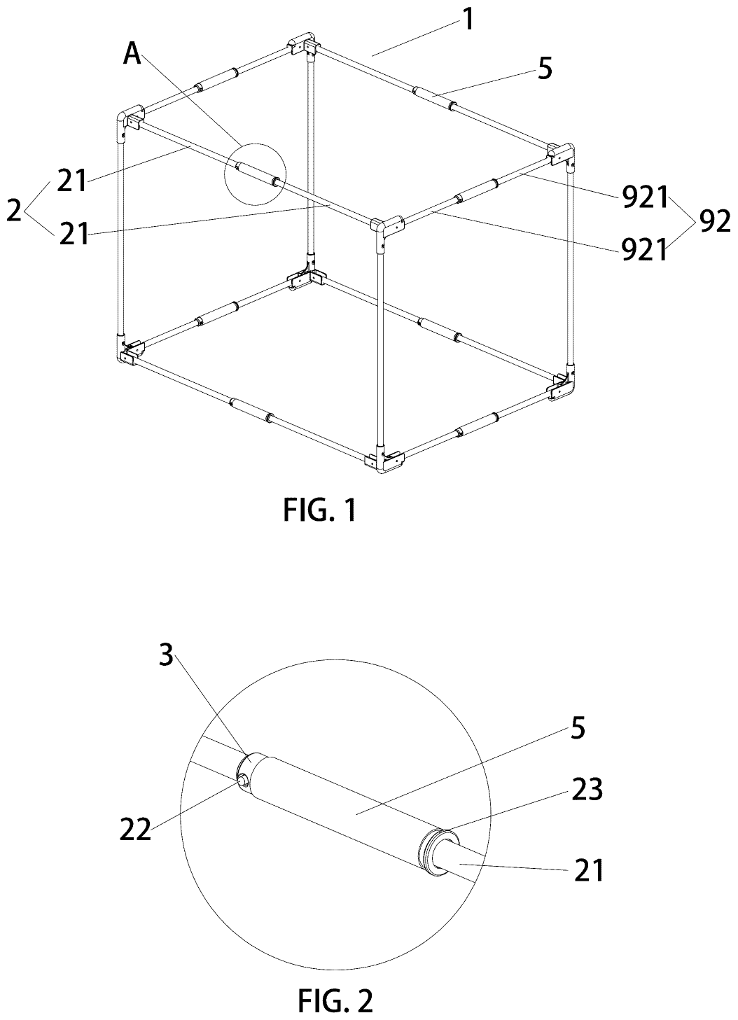

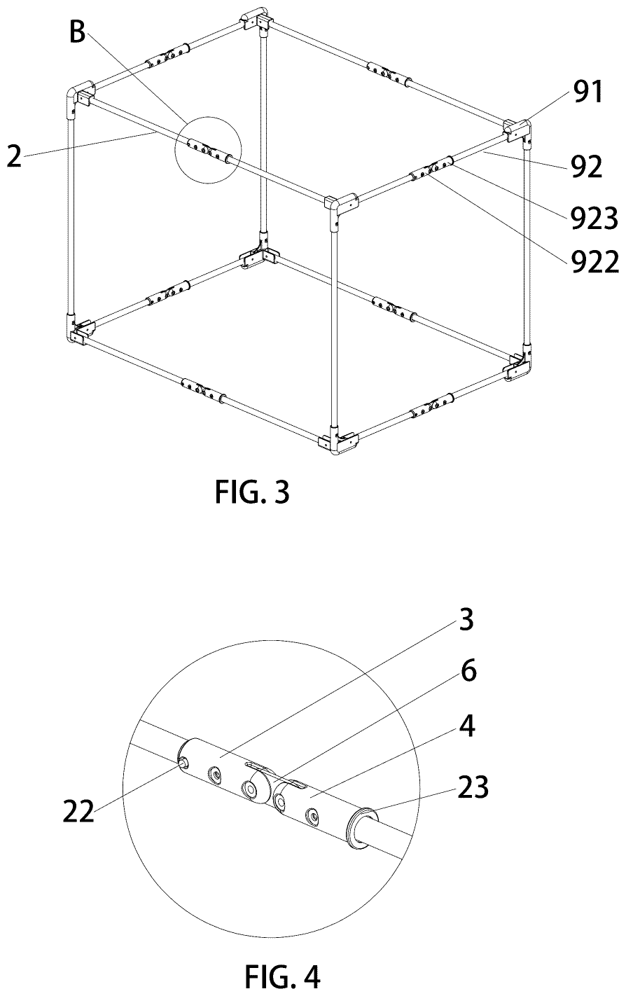

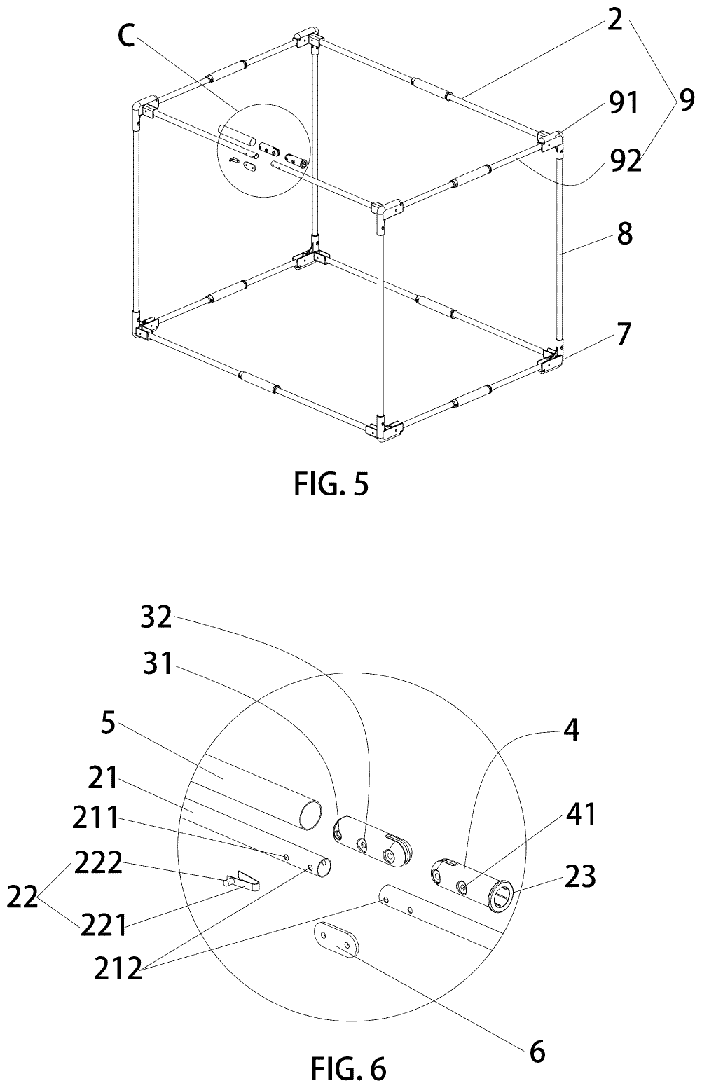

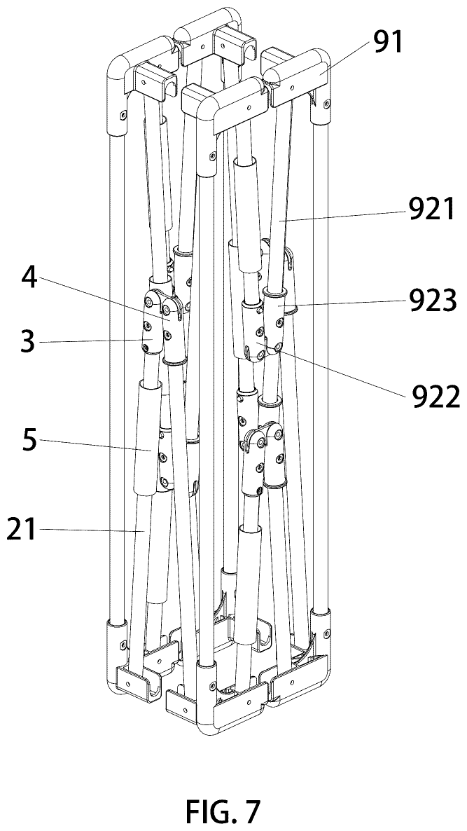

In the embodiment, as shown in FIGS. 1 to 7, an improved structure of pet cage, includes a frame body 1 on which a long support rod 2 is provided, wherein the long support rod 2 includes two first connecting pipes 21, one end of the two first connecting pipes 21 is provided with a first hinge joint 3 and a second hinge joint 4, and the other end of the two first connecting pipes 21 is movably connected to the frame body 1, one of the first connecting pipes 21 is also provided with a sleeve 5, and the sleeve 5 is placed around the hinge joint of the first hinge joint 3 and the second hinge joint 4.

In the specific embodiment, one first connecting pipe 21 is provided with an elastic limit buckle 22 and the first hinge joint 3, and the elastic limit buckle 22is located on one side of the sleeve 5, while the other first connecting pipe 21 is provided with a limit member 23 and the second hinge joint 4, and the limit member 23 is located on the other side of the sleeve 5.

In the embodiment, the elastic limit buckle 22 includes a V-shaped shrapnel 221 and a limit buckle 222 fixed at one end of the V-shaped shrapnel 221, the position of corresponding limit buckle 222 on a first connecting tube 21 is provided with a first through-hole 211, and the position of corresponding first through-hole 211 on a first hinge joint 3 is provided with a second through-hole 31, the V-shaped shrapnel 221 is disposed inside the first connecting tube 21, and one end of the limit buckle 222 extends outward outside the first through-hole 211 and the second through-hole 31.

In the embodiment, the limit member 23 is a annular limit ring, and the annular limit ring is connected to one side of the second hinge joint 4; more specifically, the annular limit ring is integrally formed with one side of the second hinge joint 4.

In a more specific embodiment, both first connecting pipes 21 are provided with connecting through-holes 212, the first hinge joint 3 is provided with a first connecting hole 32 at the position corresponding to the connecting through-hole 212, the second hinge joint 4 is provided with a second connecting hole 41 at the position corresponding to the connecting through-hole 212, the first connecting hole 32 is connected with a connector, and one end of the connector is connected to the connecting through-hole 212, the second connecting hole 41 is connected with a connector, and one end of the connector is connected to the connecting through-hole 212, (the connector, which is not shown in the figure, can be a connecting screw or rivet, and the connector).

In the embodiment, the improved structure of pet cage includes a hinge piece 6, and the hinge piece 6 is located between the first hinge joint 3 and the second hinge joint 4, and the two ends of the hinge piece 6 are respectively hinged with the first hinge joint 3 and the second hinge joint 4.

In a more specific embodiment, the frame body 1 includes a bottom frame 7, four side support rods 8, and a top frame 9, the top frame 9 includes four tee joints 91, two short support rods 92, and two long support rods 2, one end of the short support rod 92 and one end of the long support rod 2 in a similar position are movably connected to the two ends of the tee joint 91, so that the top frame 9 forms a square frame body, the four tee joints 91 on the top frame 9 are respectively connected to the upper ends of the four side support rods 8, and the lower ends of the four side support rods 8 are fixedly connected to the surrounding areas of the bottom frame 7.

In the embodiment, the short support rod 92 includes two second connecting pipes 921, and one end of the two second connecting pipes 921 is respectively provided with a third hinge joint 922 and a fourth hinge joint 923 that are mutually hinged, one of the second connecting pipes 921 is further provided with a slidable sleeve 5, the slidable sleeve 5 is sleeved around the hinge joint of the third hinge joint 922 and the fourth hinge joint 923, and the other end of the two second connecting pipes 921 is movably connected with the corresponding tee joint 91, respectively.

In the preferred embodiment, the third hinge joint 922 has the same shape and size as the first hinge joint 3, the fourth hinge joint 923 has the same shape and size as the second hinge joint 4, the bottom frame 7 and top frame 9 have the same shape and size, and the bottom frame 7 and top frame 9 are symmetrically disposed at the upper and lower ends of the side support rod 8.

What is claimed is:

1. An improved structure of pet cage, including a frame body (1) on which a long support rod (2) is provided, wherein the long support rod (2) includes two first connecting pipes (21), one end of the two first connecting pipes (21) is provided with a first hinge joint (3) and a second hinge joint (4), and the other end of the two first connecting pipes (21) is movably connected to the frame body (1), one of the first connecting pipes (21) is also provided with a sleeve (5), and the sleeve (5) is placed around the hinge joint of the first hinge joint (3) and the second hinge joint (4).

2. The improved structure of pet cage according to claim 1, wherein one first connecting pipe (21) is provided with an elastic limit buckle (22) and the first hinge joint (3), and the elastic limit buckle (22) is located on one side of the sleeve (5), while the other first connecting pipe (21) is provided with a limit member (23) and the second hinge joint (4), and the limit member (23) is located on the other side of the sleeve (5).

3. The improved structure of a pet cage according to claim 2, wherein the elastic limit buckle (22) includes a V-shaped shrapnel (221) and a limit buckle (222) fixed at one end of the V-shaped shrapnel (221), the position of corresponding limit buckle (222) on a first connecting tube (21) is provided with a first through-hole (211), and the position of corresponding first through-hole (211) on a first hinge joint (3) is provided with a second through-hole (31), the V-shaped shrapnel (221) is disposed inside the first connecting tube (21), and one end of the limit buckle (222) extends outward outside the first through-hole (211) and the second through-hole (31).

4. The improved structure of pet cage according to claim 2, wherein the limit member (23) is a annular limit ring, and the annular limit ring is connected to one side of the second hinge joint (4).

5. The improved structure of pet cage according to claim 2, wherein both first connecting pipes (21) are provided with connecting through-holes (212), the first hinge joint (3) is provided with a first connecting hole (32) at the position corresponding to the connecting through-hole (212), the second hinge joint (4) is provided with a second connecting hole (41) at the position corresponding to the connecting through-hole (212), the first connecting hole (32) is connected with a connector, and one end of the connector is connected to the connecting through-hole (212), the second connecting hole (41) is connected with a connector, and one end of the connector is connected to the connecting through-hole (212).

6. The improved structure of pet cage according to claim 5, further including a hinge piece (6), and the hinge piece (6) is located between the first hinge joint (3) and the second hinge joint (4), and the two ends of the hinge piece (6) are respectively hinged with the first hinge joint (3) and the second hinge joint (4).

7. The improved structure of pet cage according to claim 1, wherein the frame body (1) includes a bottom frame (7), four side support rods (8), and a top frame (9), the top frame (9) includes four tee joints (91), two short support rods (92), and two long support rods (2), one end of the short support rod (92) and one end of the long support rod (2) in a similar position are movably connected to the two ends of the tee joint (91), so that the top frame (9) forms a square frame body, the four tee joints (91) on the top frame (9) are respectively connected to the upper ends of the four side support rods (8), and the lower ends of the four side support rods (8) are fixedly connected to the surrounding areas of the bottom frame (7).

8. The improved structure of pet cage according to claim 7, wherein the short support rod (92) includes two second connecting pipes (921), and one end of the two second connecting pipes (921) is respectively provided with a third hinge joint (922) and a fourth hinge joint (923) that are mutually hinged, one of the second connecting pipes (921) is further provided with a slidable sleeve (5), the slidable sleeve (5) is sleeved around the hinge joint of the third hinge joint (922) and the fourth hinge joint (923), and the other end of the two second connecting pipes (921) is movably connected with the corresponding tee joint (91), respectively.

9. The improved structure of pet cage according to claim 8, wherein the third hinge joint (922) has the same shape and size as the first hinge joint (3), the fourth hinge joint (923) has the same shape and size as the second hinge joint (4), the bottom frame (7) and top frame (9) have the same shape and size, and the bottom frame (7) and top frame (9) are symmetrically disposed at the upper and lower ends of the side support rod (8).
